(19) United States
(12) Patent Application Publication
(10) Pub. No.: US 2005/0196603 A1
(43) Pub. Date: Sep. 8, 2005

(54) Anti-microbial breathable laminate

(76) Inventors: Mark E. Carr, Pipersville, PA (US); Brian Parker, Feastarville, PA (US); William F. McNally, Clarks Summit, PA (US); Satish Chandra, Lansdale, PA (US); Vinesh Naik, DuPont, PA (US); Joel M. Furey, Stowe, VT (US)

Correspondence Address: MERCHANT & GOULD PC, P.O. BOX 2903, MINNEAPOLIS, MN, 55402-0903, US

(21) Appl. No.: 11/054,835

(22) Filed: Feb. 9, 2005

Related U.S. Application Data
(60) Provisional application No. 60/551,323, filed on Mar. 8, 2004.

(51) Int. Cl. B32B 27/00

(52) U.S. Cl. 428/319.3; 428/316.6; 428/319.7; 428/195.1

(57) ABSTRACT

A multilayer breathable fabric providing protection against microbial growth, along with anti-odor, anti-static, heat and moisture transfer is disclosed. The breathable fabric includes, in certain embodiments, a membrane containing a porous scaffold material having a void volume and an interconnecting microstructure, and may have a resin composition applied to at least one surface of the scaffold material. The fabric further includes silver-containing substrate placed in contact with the membrane, the silver-containing substrate being secured to the membrane by an adhesive system.

### REFERENCE TO PRIORITY APPLICATION

This application claims the benefit of Provisional Application No. 60/551,323, filed Mar. 8, 2004, which is incorporated by reference herein in its entirety.

### BACKGROUND OF THE INVENTION

Breathable fabrics that allow transfer of water vapor, such as fabrics containing polytetraflouroethylene (PTFE) membranes, have become important in a wide number of applications. These applications include, for example, use in all-weather clothing, medical garments, and environmental protection suits. These fabrics also have uses in various non-clothing applications, such as particulate filtration media.

Breathable fabrics are particularly useful for garments that will be used in wet environments and for active pursuits where a user will produce significant amounts of perspiration. Under such circumstances a breathable garment with a PTFE membrane can provide an improved level of comfort for the wearer, while preventing excess moisture from penetrating into the interior of the garment.

Unfortunately, current breathable fabrics are susceptible to growth of microorganisms, such as molds and bacteria that will damage the fabric or will produce an unpleasant odor. These fabrics are particularly susceptible to the growth of microorganisms when a garment is worn for an extended period without being changed, is used in extremely moist and dirty environments, or when the garment is used under circumstances where it will not dry for extended periods. For example, garments worn by military personnel are sometimes subjected to long periods in extreme environments where they do not have an opportunity to dry. Therefore, a need exists for a breathable fabric that is resistant to the growth of microorganisms.

### SUMMARY OF THE INVENTION

The present invention helps to limit some of the most troublesome problems with fabrics that will be placed in extreme environments. In particular, the present invention helps control microbial growth in garments that will be subjected to extended periods in high moisture environments.

The present invention is directed, in part, to a multilayer breathable fabric. The fabric comprises, in some implementations, a single component, bi-component or multi-component membrane having a porous scaffold material with a void volume of at least 60% (which can be varied based on the application) and an interconnecting microstructure. This membrane may also have a resin composition applied to at least one surface of the scaffold material. The resin typically partially fills the voids in the scaffold sufficiently to create adhesion of the resin to the scaffold material, but not such that all voids within the scaffold are filled. The breathable fabric also includes a specialized silver-containing substrate, such as the substrate known as X-Static® available from Noble Fiber Technologies, placed in contact with the membrane, the silver-containing substrate typically being secured to the membrane by a discontinuous adhesive layer.

The invention is also directed to a multi-layer fabric comprising a breathable membrane, the breathable membrane combining an expanded PTFE film partially impregnated with a resin material; and a silver-containing layer in contact with the breathable membrane. The resin material comprises, for example, polyurethane. The laminate also can contain a woven nylon layer, wherein the breathable membrane is laminated to the woven nylon layer. The position of the silver-containing substrate in this construction can be at any layer. This is a unique characteristic of the silver-containing substrate because irrespective of where it is positioned in the construction, once the microorganism comes in contact with the silver, it is killed, thereby eliminating or reducing odor.

The silver-containing substrate suitable for use with the invention typically has silver metallized to the “outside” of a polymer. This configuration provides favorable interaction with the host environment, thereby enabling “active” ions to be available as an effective and efficient anti-microbial system with regards to the use of silver.

The exposed silver can result in reduction in the residual problems associated with bacterial colonization and odor. Bacteria release ammonia as a waste product and this offensive byproduct of bacteria is one of the principal causative agents in human-based odors. The silver-containing layer's rapid bactericidal performance reduces the opportunity for bacteria to produce ammonia. The response to stimuli (in this case bacteria and moisture) provides a zone of inhibition against bacteria provided by the silver ions. As silver is also a highly conductive metal both electrically and thermally, it provides great thermal, moisture transfer, and anti-static properties.

Additional aspects of embodiments of the invention include a microbe-resistant breathable membrane, the breathable membrane comprising an expanded PTFE film that may or may not be partially impregnated with a resin material and a silver-containing layer in contact with the breathable membrane. In such implementations the PTFE film is desirably partially impregnated with polyurethane.

The above summary of the present invention is not intended to describe each discussed embodiment of the present invention. This is the purpose of the figures and the detailed description that follow.

### DETAILED DESCRIPTION OF THE INVENTION

The present invention helps to limit some of the most troublesome problems with fabrics that will be placed in extreme environments. In particular, the present invention helps control microbial growth in garments that will be subjected to extended periods in high moisture environments.

The present invention is directed, in part, to a multilayer breathable fabric. The fabric comprises a membrane having a porous scaffold material with a void volume of at least 60% and an interconnecting microstructure. This membrane may also have a resin composition applied to at least one surface of the scaffold material. The resin partially fills the voids in the scaffold sufficiently to create adhesion of the resin to the scaffold material, but not such that all voids within the scaffold are filled. The breathable fabric also includes a silver-containing substrate placed in contact with the membrane, the silver-containing substrate being secured to the membrane by a discontinuous adhesive layer.

The benefits of the present invention include the material being very waterproof, as measured by a water column in excess of 10 meters, having good moisture vapor transfer rate in excess of 600 gm/m²/24 hours, and having an anti-microbial/anti-odor property.

Multilayer Anti-Microbial Laminate

The present invention is directed, in part, to a fabric laminate containing at least two layers, the laminate comprising a bicomponent breathable membrane and a silver-containing substrate. In certain embodiments the silver-containing substrate forms at least two interface zones across the laminate: a first interface zone wherein the silver-containing substrate is in adhesive contact with a resin material, such as polyurethane, and a second interface zone wherein the silver-containing substrate is in non-adhesive contact with the bicomponent membrane.

In addition to providing good moisture vapor transfer, in typical implementations the laminate fabric will have a water column greater than 3 meters, generally more than 5 meters, desirably more than 7 meters, and preferably greater than 10 meters. However, in some implementations where water resistance need not be at a maximum, the water column can be significantly less than these numbers. Waterproofness is measured by the ability of the material to hold back a column of water over a defined period of time. The test method used is ISO 811.

In general the laminate fabric of the present invention has a high moisture vapor rate, usually in excess of 400 gm/m²/24 hours, and preferably greater than 600 gm/m²/24 hours and may be in excess of 800 gm/m²/24 hours. Moisture vapor transmission rate is the measure of a fabric to pass water vapor through to the exterior of a garment while maintaining its waterproof characteristics. The test method utilized for these measurements is ASTM E96B.

Breathable Membrane

The invention is also directed to a multi-layer fabric comprising a breathable membrane, the breathable membrane combining an expanded PTFE film which may or may not be partially impregnated with a resin material; and a silver-containing substrate in contact with the breathable membrane. The resin material comprises, for example, polyurethane. The membrane can be made in accordance with the teachings of U.S. Pat. Nos. 3,953,566; 4,187,390; and 4,194,041, incorporated herein by reference. The laminate also can contain a woven nylon layer, wherein the breathable membrane is laminated to the woven nylon layer. In some embodiments the porous scaffold material is at least 5 microns thick. It is typically from 10 to 225 microns thick. In certain embodiments it is less than 50 microns thick.

Silver-Containing Anti-Microbial Substrate

The silver-containing substrate provides anti-microbial, anti-static and other therapeutic attributes. Examples of such silver-containing substrates include X-Static® fabric, which is a fabric or fiber base coated with silver. Suitable substrates to be coated by the silver include, for example, polyester, various forms of Kevlar®, and various forms of Nomax®. The silver-containing substrate includes, but is not limited to, the following weight ranges measured in ounces per square yard (OPSY):

| | Weight |
|---|---|
| Fabric Type | (OPSY) |
| Non-woven fabric | 0.25-3 |
| Tricot fabric | 1-5 |
| Stretch fabric | 2-9 |
| Plain weave | 1-4 |
| Ripstop fabric | 1-4 |

Other types of fabric can be knit using a spun yarn with silver-containing substrate. Typically the % of silver-containing substrate in such fabrics has the following properties:

| | silver- |
|---|---|
| | containing |
| | substrate |
| Range | (% W/w) |
| Outside range | 0.01-20 |
| Intermediate range | 0.1-15 |
| Optimal range | 1-10% |
| Ideal | ˜7 |

The typical lengths and Denier of the above-stated staple are:

| | | Denier |
|---|---|---|
| | Length | (dpf) |
| Outside range | ½-8 | .5-50 |
| Intermediate range | ¾-6 | .7-30 |
| Optimal range | 1-3 | 1-10 |
| Ideal | ˜2 | ˜3 |

The silver present in the X-Static® fabric is detailed below:

| | Silver |
|---|---|
| Range | (% w/w) |
| Outside range | 0.1-42 |
| Intermediate range | 4-35 |
| Optimal range | 12-30% |
| Ideal | ˜20 |

Articles Incorporating Anti-Microbial Breathable Fabric

The present invention provides an advantage by producing a waterproof or water-resistant fabric that also shows effective resistance to microorganism growth relative to prior fabrics. Such articles also help in eliminating odor, and providing heat and moisture transfer along with anti-static protection. In addition, in some embodiments of the invention the fabric shows breathability similar or equal to the breathability of fabrics that are not microbe resistant. Applications for the material include shoe and boot liners, mittens, gloves, hats, coats, trousers, waders, protective coveralls, medical gowns and drapes.

In addition, the invention is directed to a garment system configured to control microbial growth. The garment system includes a first garment, said first garment configured and arranged to be positioned on the exterior of a person, the first garment also configured to be substantially resistant to penetration of liquid water from the exterior environment; and a second garment, said second garment configured and arranged such that it is worn intermediate the first garment and a person, the second garment providing no resistance to water movement. The first and second garments are free to move with regard to one another.

The first garment also comprises a bicomponent membrane containing a porous scaffold material having a void volume of at least 60 percent and an interconnecting microstructure, and a resin composition applied to at least one surface of the scaffold material, wherein the resin partially fill the voids sufficient to create adhesion of the resin to the scaffold material, but not such that all voids within the scaffold are filled; plus a silver containing substrate placed in contact with the bicomponent membrane, the silver containing substrate being secured to the bicomponent membrane by a discontinuous adhesive layer. In some implementations the second garment is at least 500 percent more porous than the first garment.

While the present invention has been described with reference to several particular implementations, those skilled in the art will recognize that many changes may be made hereto without departing from the spirit and scope of the present invention.

### EXAMPLES

The invention can now be understood by review of the following experimental data and examples:

### Example 1

An anti-microbial breathable laminate was made using the following three layers: Navy Blue Nylon 6,6 Taslan, PTFE, and nylon 6,6 tricot X-Static®.

### Example 2

A sample obtained from example 1 was cut to a weight of 0.75 gm and was subjected to Dow Corning Corporate Test Method 0923 to determine impact on organism growth. The organism used was Staphylococcus aureus ATCC 6538. Reduction of organism growth was over 99.9% in less than 4 hours time.

### Example 3

A sample from example 1 was tested for silver ion release. The fabric was cut to a 1.5 gm piece and then placed in a beaker with 5% sodium chloride solution for a 24-hour period. The solution after a 24-hour period was then tested for silver ions using a Perkin Elmer Aanalyst 300. The same test was repeated over a period of 7 days. The release of ions was consistent each day at 0.5 ppm.

### Example 4

A sample from example 1 was tested for its conductive properties. Resistance recorded using a Keithley 580 micro-ohmmeter was <1 ohm per square cm. A bi-component layer of PTFE and spun X-Static® (5% W/w) was tested for it's anti-static properties. The test was conducted under Fed. Test Method Std. 191A, Method 5931. The results are listed below:

| | Maximum | Minimum | | |
|---|---|---|---|---|
| | Time for | Time for | | |
| | Discharge in | Discharge in | | |
| Voltage | Minutes | Minutes | Average | σ |
| +5 KV | 0.01 | 0.01 | 0.01 | 0 |
| −5 KV | 0.01 | 0.01 | 0.01 | 0 |

Moisture Vapor Transfer Rate (MVTR) was measured using the following procedure; the rate of moisture vapor diffusion through the fabric was determined according to ASTM E96-80. A sample of 3-ply laminate was placed on a water dish (82 mm in diameter and 19 mm in depth) allowing a 9 mm air space between the water surface and specimen. A vibration-free turntable carrying 8 dishes rotated uniformly at 5 meters per minute to insure that all dishes were exposed to the same average ambient conditions during the test. The assembled specimen dishes were allowed to stabilize for two hours before taking the initial weight. They were weighed again after a 24-hour interval. Then the rate of moisture vapor loss (MVTR) was calculated in units of g/m²/24 hours. A higher MVTR value indicates there is a greater passage of moisture vapor through the material with 600 being considered as excellent. The final result for MVTR value was calculated to be 779 g/m².

1. A multilayer breathable fabric, the breathable fabric comprising:
a) a bicomponent membrane containing:
i) a porous scaffold material having a void volume of at least 60% and an interconnecting microstructure, and
ii) a resin composition applied to at least one surface of the scaffold material,
wherein the resin partially fill the voids sufficient to create adhesion of the resin to the scaffold material, but not such that all voids within the scaffold are filled, and
b) a silver-containing substrate placed in contact with the bicomponent membrane, and being secured to the bicomponent membrane by a discontinuous adhesive layer.

2. The multilayer breathable fabric of claim 1, wherein the porous scaffold material comprises polytetraflouroethylene.

3. The multilayer breathable fabric of claim 1, wherein the porous scaffold material is at least 10 microns thick.

4. A multi-layer fabric comprising:
a breathable membrane, the breathable membrane combining an expanded PTFE film partially impregnated with a resin material; and
silver-containing substrate in contact with the breathable membrane.

5. The multi-layer fabric of claim 4, wherein the resin material comprises polyurethane.

6. The multi-layer fabric of claim 4, wherein the laminate further comprises a woven nylon layer, and wherein the breathable membrane is laminated to the woven nylon layer.

7. The multi-layer fabric of claim 4, wherein the silver-containing substrate layer comprises non-wovens, tricot, stretch, plain weave, ripstop and other fabric designs.

8. The multi-layer fabric of claim 4, wherein the silver-containing substrate spun yarn uses staple silver-containing substrate of various lengths and Deniers.

9. The multi-layer fabric of claim 4, wherein the silver is present in from 0.1% to 42% percent by weight of the silver-containing layer.

10. A microbe-resistant breathable membrane, the breathable membrane comprising:
an expanded PTFE film partially impregnated with a resin material; and
silver-containing substrate in contact with the breathable membrane.

11. The microbe-resistant breathable membrane of claim 10, wherein the PTFE film is partially impregnated with polyurethane.

12. The microbe-resistant breathable membrane of claim 10, wherein the silver-containing layer comprise a non-woven, tricot, stretch, plain weave, or ripstop weave.

13. The anti-microbial silver-containing substrate from claim 10, also providing anti-static properties.

14. The anti-microbial silver-containing substrate from claim 10, also providing anti-odor properties.

15. The anti-microbial silver-containing substrate from claim 10, also providing efficient heat transfer properties.

16. The anti-microbial silver-containing substrate from claim 10, also providing efficient moisture transfer properties.

17. A microbe-resistant breathable membrane, the breathable membrane comprising an expanded PTFE film; and silver-containing substrate in contact with the breathable membrane.
